(19) United States
(12) Patent Application Publication
(10) Pub. No.: US 2008/0085450 A1
(43) Pub. Date: Apr. 10, 2008

(54) End cap seal assembly for an electrochemical cell

(76) Inventor: Christopher L. DePalma, Southbury, CT (US)

Correspondence Address: MR. BARRY D. JOSEPHS;ATTORNEY AT LAW, 19 NORTH STREET, SALEM, MA, 01970, US

(21) Appl. No.: 11/543,647

(22) Filed: Oct. 5, 2006

(51) Int. Cl. H01M 2/08; H01M 2/12

(52) U.S. Cl. 429/174; 429/56

(57) ABSTRACT

An end cap assembly for an electrochemical cell such as an alkaline cell is disclosed. The end cap assembly is inserted into the open end of a cylindrical housing for the cell in order to seal the housing. The end cap assembly comprises a metal support disk and underlying insulating sealing disk. The insulating sealing disk has a central hub and radial arm extending therefrom. The insulating sealing disk has a thinned portion within the radial arm. The thinned portion forms a rupturable membrane, which can rupture when gas pressure within the cell rises. The rupturable membrane is inclined so that it has a high point which is closer to the cell's central longitudinal axis than the membrane's low point, when the cell is viewed with the end cap assembly on top. The inclined membrane provides more space between the insulating disk and the metal support disk into which the membrane can rupture.

### FIELD OF THE INVENTION

The invention relates to an end cap assembly for sealing electrochemical cells, particularly alkaline cells. The invention relates to rupturable devices within the end cap assembly which allow gas to escape from the interior of the cell to the environment.

### BACKGROUND

Conventional electrochemical cells, such as alkaline cells, are formed of a cylindrical housing having an open end and an end cap assembly inserted therein to seal the housing. Conventional alkaline cells typically comprise an anode comprising zinc, a cathode comprising manganese dioxide, and an alkaline electrolyte comprising aqueous potassium hydroxide. After the cell contents are supplied, the cell is closed by crimping the housing edge over the end cap assembly to provide a tight seal for the cell. The end cap assembly comprises an exposed end cap plate which functions as a cell terminal and typically a plastic insulating plug, which seals the open end of the cell housing. A problem associated with design of various electrochemical cells, particularly alkaline cells, is the tendency of the cell to produce gases as it continues to discharge beyond a certain point, normally near the point of complete exhaustion of the cell's useful capacity. Electrochemical cells, particularly alkaline cells, are conventionally provided with rupturable diaphragms or rupturable membranes within an end cap assembly. The rupturable diaphragm or membrane may be formed within a plastic insulating member as described, for example, in U.S. Pat. No. 3,617,386. Such diaphragms are designed to rupture when gas pressure within the cell exceeds a predetermined level. The end cap assembly may be provided with vent holes for the gas to escape when the diaphragm or membrane is ruptured. The end cap assembly disclosed in U.S. Pat. No. 3,617,386 discloses a grooved rupturable seal diaphragm and a separate metal contact disk between the end cap and seal diaphragm. The end cap assembly disclosed in the reference is not designed to withstand radial compressive forces and will tend to leak when the cell is subjected to extremes in hot and cold climate.

In order to provide a tight seal contemporary prior art typically disclose end cap assemblies which include a metal support disk inserted between the end cap plate and an insulating member. The separate metal support disk may be radially compressed when the cell housing edge is crimped over the end cap assembly. The insulating plug is typically in the form of a plastic insulating disk which extends from the center of the cell towards the cell housing and electrically insulates the metal support disk from the cell housing. The metal support disk may have a highly convoluted surface as shown in U.S. Pat. Nos. 5,759,713 or 5,080,985 which assures that end cap assembly can withstand high radial compressive forces during crimping of the cell's housing edge around the end cap assembly. This results in a tight mechanical seal around the end cap assembly at all times.

The prior art discloses rupturable vent membranes which are integrally formed as thinned areas within the insulating disk included within the end cap assembly. Such vent membranes are normally oriented such that they lie in a plane perpendicular to the cell's longitudinal axis, for example, as shown in U.S. Pat. No. 5,589,293. In U.S. Pat. No. 4,227,701 the rupturable membrane is formed of an annular “slit or groove” located in an arm of the insulating disk which is slanted in relation to the cell's longitudinal axis. The insulating disk is slideably mounted on an elongated current collector running therethrough. As gas pressure within the cells builds up the center portion of the insulating disk slides upwards towards the cell end cap, thereby stretching the thinned membrane “groove” until it ruptures. U.S. Pat. Nos. 6,127,062 and 6,887,614 B2 disclose an insulating sealing disk and an integrally formed rupturable membrane therein which is inclined, but the insulating disk and metal support disk abut so there is no head space therebetween. When the gas pressure within the cell rises the membrane ruptures thereby releasing the gas pressure to the external environment.

The rupturable membrane can be in the form of one or more “islands” of thin material within the insulating disk as shown in U.S. Pat. Nos. 4,537,841; 5,589,293; and 6,042,967. Alternatively, the rupturable membrane can be in the form of a thin portion circumventing the cell'longitudinal axis as shown in U.S. Pat. Nos. 5,080,985 and 6,991,872. The circumventing thinned portion forming the rupturable membrane can be in the form of slits or grooves within the insulating disk as shown in U.S. Pat. Nos. 4,237,203 and 6,991,872. The rupturable membrane may also be a separate piece of polymeric film which is sandwiched between the metal support disk and the insulating disk and facing apertures therein as shown in Patent Application Publication US 2002/0127470 A1. A pointed or other protruding member can be oriented above the rupturable membrane to assist in rupture of the membrane as shown in U.S. Pat. No. 3,314,824. When gas pressure within the cell becomes excessive, the membrane expands and ruptures upon contact with the pointed member, thereby allowing gas from within the cell to escape to the environment through apertures in the overlying terminal end cap.

A separate metal support disk, typically with convoluted surfaces as shown in U.S. Pat. Nos. 5,080,985 and 5,759,713, has been commonly included within the end cap assembly. The metal support disk provides support for the plastic insulating seal and withstands high radial compressive forces which may be applied to the end cap assembly during crimping of the housing edge around the end cap assembly. The high radial compressive force assures that the seal along the peripheral edge of the end cap assembly and cell housing can be maintained even if gas pressure within the cell builds up to elevated levels a very high level, for example, over 1000 psia (689.4×10⁴ pascal).

In U.S. Pat. No. 4,537,841 is shown a plastic insulating seal for closing the open end of a cylindrical alkaline cell. There is a metal support disk over the insulating seal. The plastic insulating seal has a central hub and integrally formed radial arm which extends radially from the hub to the cell's casing wall. An “island” type rupturable membrane is formed integrally within the radially extending arm of the insulating seal. The “island” rupturable membrane is formed by compressing a portion of the radially extending arm of the insulating seal thereby forming a small circular thinned island portion, which is designed to rupture when gas pressure within the cell reaches a predetermined level. The island rupturable membrane shown in this reference is level with the radially extending arm of the insulating seal, that is, it is oriented in a plane perpendicular to the cell's central longitudinal axis. Furthermore, the top surface of the thinned rupturable membrane (facing the cell's open end) is very nearly level with the top surface of the radially extending insulating arm. This design while effective provides only a small limited space between the rupturable membrane and the metal support disk. When the cell is subjected to abusive conditions such as abnormally high and prolonged current drain or exposure to fire, there may result in very quick rise in cell internal temperature and gassing. It is possible under such conditions that the membrane may balloon out without rupturing because the membrane softens and there is a small space between the membrane and the metal support disk. Alternatively, if the membrane does rupture under such abusive conditions, material from the cell interior may accumulate quickly within the small space between the ruptured membrane and the metal support disk without passing from the cell. Such blockage can lead to an undesirable condition in that it increases the chance of cell casing rupture and explosion.

Accordingly, it is desirable to have an alkaline cell end cap assembly which has a plastic insulating seal with a venting mechanism therein comprising a rupturable membrane. It is desirable that the membrane rupture properly even when the cell is subjected to abusive testing conditions resulting in quick rise in cell temperature and gassing.

It is desirable that the end cap assembly have a venting mechanism which is capable of venting enough gas and material from the cell interior so that it does not build up within the end cap assembly even when the cell is subjected to abusive testing conditions.

It is desirable to limit the space occupied by the end cap assembly, that is, to keep the construction of the end cap assembly compact thereby providing more available space for the cell active materials.

It is desirable to have the open edge of the separator bend easily towards the hub of the insulating seal when the end cap assembly is inserted into the open end of the cell housing.

### SUMMARY OF THE INVENTION

The invention is directed to an end cap assembly for an alkaline cell, which is used to close and seal the open end of the cylindrical housing for the cell. In one aspect the end cap assembly comprises a metal support disk and an insulating sealing disk (plastic grommet) which underlies the metal support disk, as viewed with the open end of the housing on top. The sealing disk is of electrically insulating material, preferably of durable plastic, which resists attack by alkaline electrolyte. In a specific embodiment the end cap assembly also includes an end cap which is located above the metal support disk and an insulating washer of plastic or paper located between the end cap and metal support disk.

The insulating sealing disk has an integral thinned portion therein forming an “island” type rupturable membrane. The membrane is intended to rupture when gas pressure within the cell builds up to level in which it becomes desirable to vent the gases to maintain cell safety. In particular the membrane is intended to rupture properly and release gas pressure quickly and safely should gas pressure rise abruptly, for example, if the cell is subjected to abusive testing of abuse operation such as intentional short circuiting or subjecting the cell to very high external temperatures. The insulating sealing disk and inclined rupturable membrane therein is desirably of polypropylene, preferably talc filled polypropylene, which is more cost effective than nylon.

In a principal aspect the bulk of the metal support disk is spaced apart from the insulating sealing disk. In effect at least the region of the metal support disk between its central core and peripheral edge is spaced apart from the insulating sealing disk and does not contact the sealing disk. There is no other metal disk in contact with any other part of the insulating sealing disk. In particular the rupturable membrane within the insulating sealing disk is spaced apart from the metal support disk so that there is head space over the rupturable membrane, that is, between the rupturable membrane and the metal support disk. When gas pressure within the cell rises to a predetermined level the membrane ruptures allowing gas and debris from the cell interior to pass into the such head space and then to the external environment through apertures within the metal support disk.

In a principal aspect the rupturable membrane within the insulating sealing disk is not perpendicular to nor parallel to the cell's central longitudinal axis, but rather has an inclined orientation with respect to the cell's central longitudinal axis. The invention involves the use of an “inclined” island type rupturable membrane which is integrally formed within the insulating sealing disk radially extending arm. The term “island” type rupturable membrane is a recognized term of art which refers to a localized thinned portion within the insulating sealing disk. That is, the membrane has a closed boundary defining a discernible thinned area within the sealing disk, and is not formed of an annular or circumferential groove or slit. The island type rupturable membrane of the invention preferably has top and bottom major surfaces which are flat. The membrane is “sloped” or “inclined” so that it appears out of the plane of the radially extending arm (radial arm) of the sealing disk in which it resides. In a preferred embodiment the radial arm of the sealing disk in which the rupturable membrane resides is perpendicular to the cell's central longitudinal axis and the rupturable membrane therein is inclined so that it appears out of the plane of said radial arm. The rupturable membrane is inclined or sloped so that it has a high point which is closer to the hub (central portion) of the insulating sealing disk than the low point on the rupturable membrane, when the cell is viewed in vertical position with the end cap assembly on top. The rupturable membrane is oriented at a downward acute angle, “α”, at the juncture between the membrane and vertical central hub wall of the insulating disk. The angle “α” can also be measured as the angle of intersection of the plane of the rupturable membrane and the cell's central longitudinal axis, when viewed from the cell interior. The plane of the rupturable membrane is inclined so that the high point on the rupturable membrane is closer to the cell's central longitudinal axis than the low point on the rupturable membrane, when the cell is viewed in vertical position with the with end cap assembly on top. The plane of the rupturable membrane is at an incline acute angle “α” of between about 10 and 65 degrees, desirably between about 20 and 40 degrees, with cell's central longitudinal axis.

The inclined orientation of the island rupturable membrane as above described results in the membrane being recessed out of the plane of the radial arm of the insulating sealing disk in which it resides. The rupturable membrane is recessed in the direction towards the cell interior. This in turn results in an increase in the head space immediately over the rupturable membrane, that is, an increase in the space between the rupturable membrane and the metal support disk which covers the insulting sealing disk. The increased head space provides more space into which the membrane may expand and rupture if gas within the cell rises abruptly. Such increased head space assures that the membrane will rupture even if the membrane is subjected to sudden rise in temperature which may suddenly soften the membrane. Importantly the increase head space immediately over the rupturable membrane is achieved without need to alter the position of the metal support disk in relation to the top surface of the insulating sealing disk. (Increasing the separation between the metal support disk and top surface of the rupturable membrane, per se, would reduce the amount space available in the cell interior for anode and cathode materials.) Thus, increased amount of head space immediately over the rupturable membrane is achieved by the inclined membrane orientation of the invention, without reducing the amount of space available in the cell interior for anode and cathode materials.

In another aspect of the invention the metal support disk, which covers the insulating sealing disk, is provided with a plurality of apertures located near the peripheral edge of the support disk. Such apertures facilitate the release and removal of gas and debris from the cell interior which are carried through the ruptured membrane. The release path of such gas and debris is through the ruptured membrane, apertures in the metal support disk and then to the external environment.

The inclined orientation of the rupturable membrane of the invention also results in easy capture of the top edge of the electrolyte permeable separator when the end cap assembly is inserted into the open end of housing. The rupturable membrane is inclined downward from insulating sealing disk hub to the cell housing when viewed with the cell in vertical position with the end cap assembly on top. This incline makes it easy for the top edge of the separator sheet to slide or be bent inwardly towards the hub (center) of the insulating sealing disk when the end cap assembly is inserted into the cell housing open end. In such position the top edge of the separator provides an effective barrier preventing anode material from mixing with cathode material.

### BRIEF DESCRIPTION OF THE DRAWINGS

The invention will be better understood with reference to the drawings in which:

FIG. 1 is a cross sectional elevation view of an alkaline cell showing the end cap assembly of the invention with inclined island type rupturable membrane within the insulating sealing disk.

FIG. 1A is an exploded view of the components of the end cap assembly of the invention.

FIG. 2 is a plan view of the negative end cap.

FIG. 2A is an elevation view of the current collector nail.

FIG. 3 is a top plan view of the paper washer 50.

FIG. 4 is top plan view of the metal support disk.

FIG. 5 is a top plan view of the insulating sealing disk.

FIG. 6 is a bottom plan view of the insulating sealing disk.

FIG. 7 is a cross sectional enlarged view of the insulating sealing disk showing the inclined rupturable membrane therein.

FIG. 8 is a cross sectional enlarged view of the insulating sealing disk showing the intersection of the plane of the inclined rupturable membrane with the cell's central longitudinal axis at angle “α”.

### DETAILED DESCRIPTION

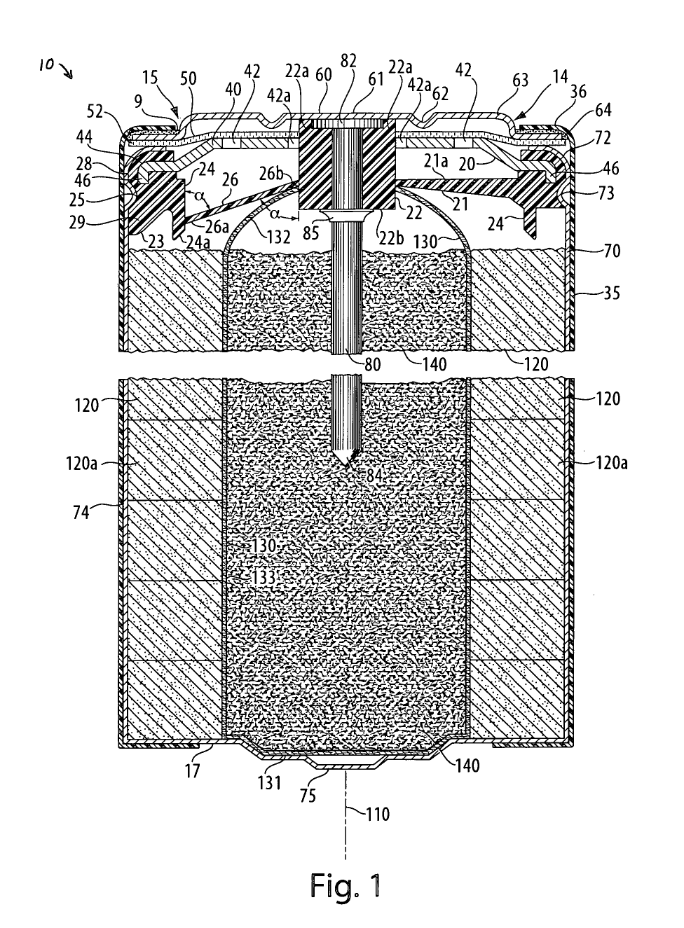

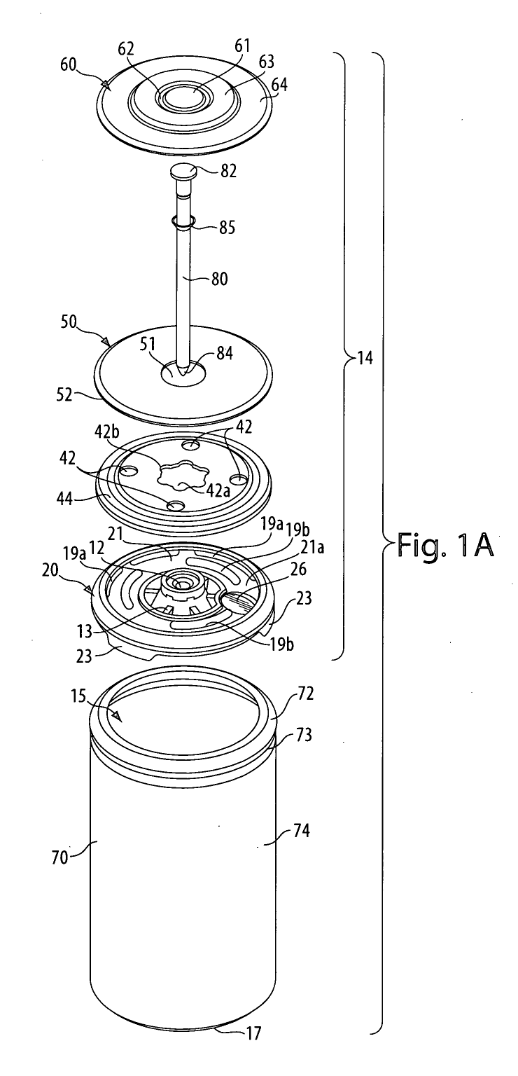

A preferred structure of the end cap assembly 14 of the invention is illustrated in FIG. 1. Cell 10 has a cell housing (casing) 70 having an open end 15 and opposing closed end 17 and integral cylindrical side wall 74. Housing 70 may be of nickel plated steel having a wall thickness typically of between about 4 and 8 mil (0.10 and 0.20 mm). Cathode material 120, typically in the form of compacted stacked disks 120a, is packed into the cell housing 70 so that it contacts the inside surface of cylindrical side wall 74 of said housing. An electrolyte permeable separator 130 is inserted into the cell housing so that it lies against the inside surface of cathode 120 as shown in FIG. 1. Separator 130 has an open top edge 132, opposing closed end 131, and sides 133 therebetween abutting cathode 120. The separator 130 for alkaline cells typically comprise cellulosic and polyvinylalcohol fibers and may, for example, consist of an inner layer of a nonwoven material of cellulosic and polyvinylalcohol fibers and an outer layer of cellophane. Anode material 140 is then inserted into the central core of housing 70 so that separator 130 separates cathode material 120 from anode material 140. End cap assembly 14 is then inserted into the open end 15 of housing 70 to close and seal the open end of the housing.

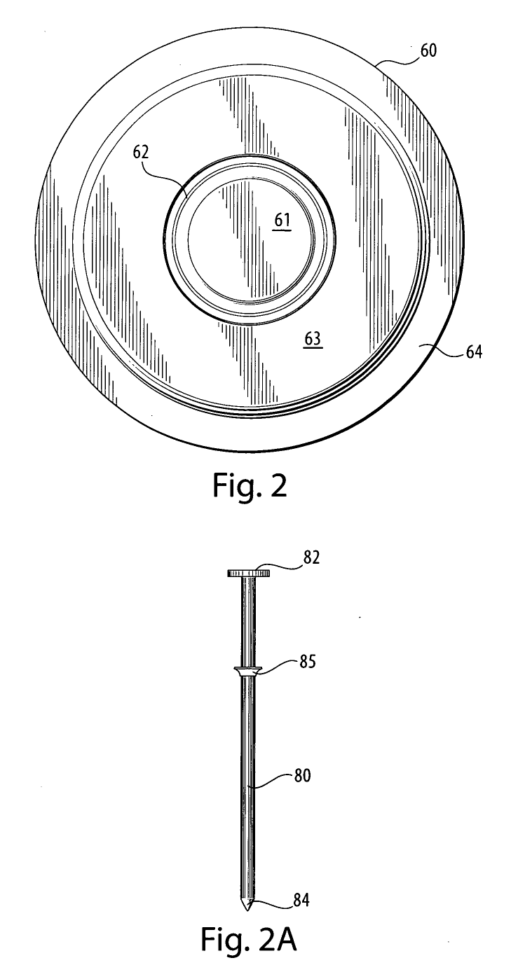

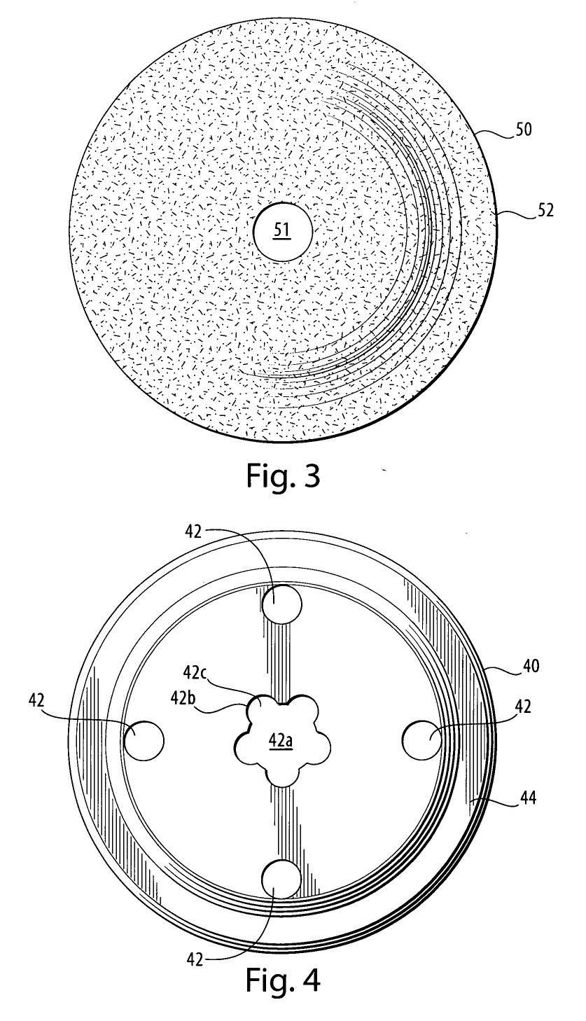

An exploded view of the components of the end cap assembly 14 is shown in FIG. 1A. End cap assembly 14 components as best shown in FIG. 1A comprises insulating sealing disk 20, a metal support disk 40 in juxtaposition over the insulating sealing disk 20, a insulating washer 50 located over the metal support disk 40 and a metal end cap 60 over the insulating washer 50. The insulating washer 50, preferably of Kraft paper, may have a single aperture 51 at its center as shown in FIG. 3. End cap assembly 14 also includes an elongated metal current collector (nail) 80 which is welded to the underside of end cap 60. The end cap 60 is desirably of nickel plated steel and as shown in FIG. 2 need not have any apertures therethrough. End cap 60 as shown in FIGS. 1 and 2 has a central contact area 61 which is electrically connected to anode 140 through current collector 80; thus contact area 61 serves as the cell's negative terminal. End cap 60 has an annular depression 62 which circumvents central contact area 61. The depression 62 is bounded radially by raised circumferential surface 63 which is at the same level as contact surface 61. Surface 63 is in turn bounded by depressed circumferential surface 64 which forms the peripheral edge of end cap 60. Current collector 80 as shown best in FIG. 2A may desirably be of brass or tin plated or indium plated brass. When the end cap assembly is in place current collector 80 penetrates into the cell interior.

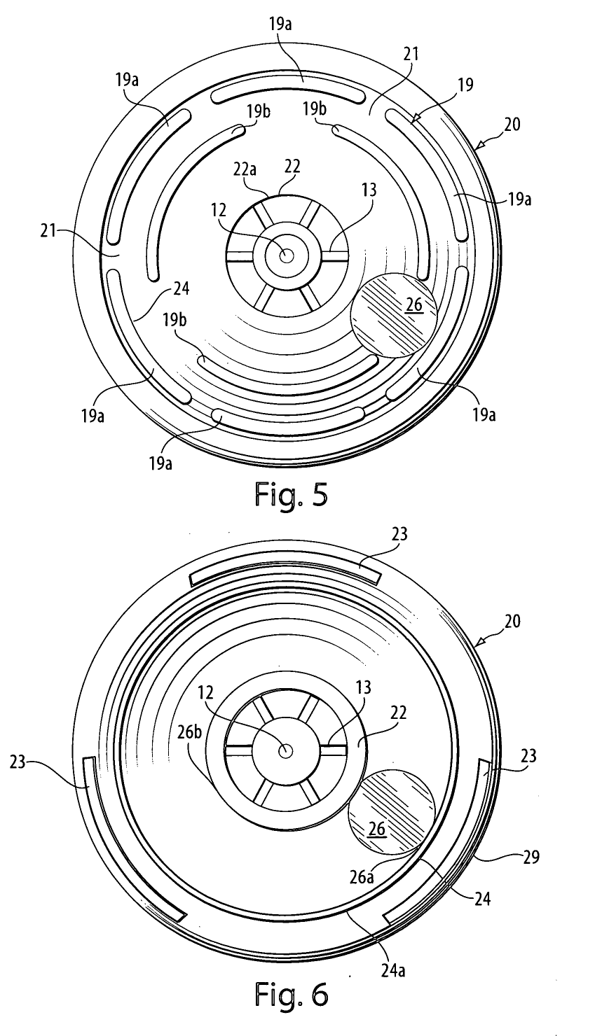

A pictorial view of the insulating sealing disk 20 before it is crimped into the cell is shown in FIG. 1A. A top plan view of the insulating sealing disk 20 is shown in FIG. 5 and a bottom plan view of insulating sealing disk 20 is shown in FIG. 6. A specific embodiment of the end cap assembly 14 integrated into an alkaline cell 10 is illustrated in FIG. 1. The end cap assembly 14 is applicable to cylindrical electrochemical cells, particularly cylindrical alkaline cells of standard AAA (44×9 mm), AA (49×12 mm), C (49×25 mm) and D (58×32 mm) size. The end cap assembly 14 provides a seal for the open end of cell housing (casing) 70 and also has incorporated therein exposed end cap 60. End cap 60 is in the form of a disk and may function as one of the cell's terminal's (negative terminal for alkaline cell) as above described and as shown in FIG. 1.

There is a metal support disk 40 which is inserted over insulating seal disk 20. The bulk of metal support disk 40 is spaced apart from insulating seal 20 forming a head space 18 therebetween (FIG. 1). Specifically, all but the peripheral edge 44 and central core 42a of the metal support disk 40 is spaced apart from insulating seal 20. There are not other metal disks or end caps in contact with insulating sealing disk 20. Metal support disk 40 may desirably be of nickel plated steel. Metal support disk 40 has a peripheral edge 44 and a central opening 42a as shown in FIG. 4. There are a plurality of spaced apart apertures 42 located near peripheral edge 44 as shown best in FIG. 4. The apertures 42 are spaced apart in a circumferential pattern. Metal support disk 40 is inserted over insulating sealing disk 20 so that central aperture 42a of the metal support disk 40 is pushed over hub 22 of the sealing disk 20. Thus hub 22 penetrates into aperture 42a so that the metal support disk 40 is held in place over the insulating sealing disk 20. Aperture 42a has a circumferential boundary with convolutions 42b forming a portion of the boundary of aperture 42a as shown in FIG. 4. These convolutions 42b form adjacent vent passages 42c (FIG. 4) through which gas may escape from the cell interior when membrane 26 in the insulating seal ruptures. Gas also escapes through vent holes 42 near the peripheral edge of the metal support disk 40.

The head 82 of metal current collector nail 80 is welded to the underside of central portion 61 of metal end cap 60 (FIG. 1). End cap assembly 14 is inserted into the open end 15 of cell 10 in the following manner: Insulating sealing disk 20, which is of plastic material, such as nylon or polypropylene, preferably talc filled polypropylene, is first inserted into the open end 15 of housing 70. Insulating sealing disk 20 has a plurality of integrally formed spaced apart legs 23 emanating from the underside of peripheral edge 29 (FIG. 1A and FIG. 6). As sealing disk 20 is inserted into housing 70, legs 23 snap over circumferential bead 73, so that the insulating disk 20 is held in place against housing 70. Metal support disk 40 is inserted over the insulating sealing disk 20 so that hub 22 of the sealing disk penetrates central aperture 42a of metal support disk 40, thereby holding the metal support disk 40 secured to the insulating sealing disk. (Metal support disk 40 can be inserted onto insulating disk 20 before the insulating disk 20 is inserted into the open end 15 of housing 70.) The peripheral edge 72 of housing 70 is then crimped over the top peripheral edge 28 of the insulating sealing disk 20. Radial crimping forces may be applied during the crimping procedure, assuring that the peripheral edge 44 of the metal support disk 40 bites into the peripheral edge 29 of the insulating seal as shown best in FIG. 1. A Kraft paper washer 50 is then inserted over the metal support disk 40 so that the edge 52 of the paper washer rests on the crimped peripheral edge 72 of housing 70. The end cap 60 is then positioned over paper washer 50. The tip 84 of current collector nail 80 is aligned with central aperture 51 in washer 50.

Insulating sealing disk 20 has a thick central boss 22 with an aperture 12 passing therethrough for receiving a metal current collector 80. Current collector 80 can be in the form of an elongated nail, preferably having an integrally formed head 82 at the top end and a tip 84 at the opposing end. Head 82 is welded to the underside of center 61 of end cap 60 as by electrical resistant welding. When assembling end cap assembly 14, current collector 80 is inserted through aperture 12 in sealing disk 20 by pushing or hammering tip 84 through aperture 12 (FIG. 5) until head 82 comes to rest against the top surface of boss 22 (FIG. 1). The tip 84 of current collector nail 80 passes through central aperture 51 in washer 50, central aperture 42a in metal support disk 40, then penetrates through aperture 12 of insulating disk 20. A major portion of the current collector nail 80 penetrates into the anode material 140. There is an integral ring flange 85 protruding from the outer surface of current collector nail 80. Flange 85 preferably circumvents the outer surface of current collector 80 at a predetermined location on the current collector surface. Flange 85 is located on current collector 80 so that it will be flush against the bottom surface 22b of insulating seal hub 22 after the current collector nail 80 is pushed through said hub. Flange 85 prevents current collector nail 80 from moving vertically upward out of insulating seal hub 22 and thus keeps current collector 80 locked in place within hub 22 (FIG. 1).

There is an integrally formed thinned portion forming island rupturable membrane 26 located within circumventing radially extending arm 21 of insulating seal 20. The rupturable membrane 26 as shown in FIGS. 1 and 1A preferably flat top and bottom surfaces and has a circular configuration. However, island membrane 26 but may be of other shapes, for example, oblong, elliptical, or polygonal, or may have a portion of its perimeter curvilinear and another portion straight sided or polygonal. Membrane 26 has a thickness which is smaller than the thickness of the surrounding radial arm 21 in which it resides. Rupturable membrane 26 has a thickness which allows the membrane to rupture when gas pressure within the cell builds up to a predetermined pressure. The membrane 26 thickness may typically be between about 0.06 and 0.50 mm, preferably between about 0.06 and 0.15 mm when the insulating seal 20 and membrane 26 is formed of polypropylene or talc filled polypropylene. The top surface area of membrane 26 may desirably be between 10 and 40 mm². Preferably the top surface area of membrane 26 is about 32 mm² for a D size cell. For a C size cell a desired membrane rupture pressure may be between about 300 and 700 psia (206.8×10⁴ and 482.6×10⁴ pascal), desirably about 510 psia (351.6×10⁴ pascal) and for a D size cell a desired membrane rupture pressure may be between about 200 and 450 psia (137.8×10⁴ and 310.2×10⁴, desirably about 310 psia (213.7×10⁴ pascal). For an AAA or AA size cell the desired membrane rupture pressure may typically between about 400 and 1200 psia (275.8×10⁴ and 827.3×10⁴ pascal). Although the end cap assembly 14 and rupturable membrane 26 configuration of the invention is applicable to any size alkaline cell, including AAA, AA, C, and D size cell, it has greatest applicability for C and D size alkaline cells.

The following relationship shows the approximate relationship between the desired rupture pressure P_{R}, the radius “R” of the rupturable membrane 26, and thickness “t” of the membrane, where “S” is the ultimate tensile strength of the rupturable material.

Pᵣ=S×t/R (I)

For example, if it is desired to design for a low burst pressure, the radius of the rupturable membrane 26 should be made large (or as large as possible) and the thickness of membrane 26 small (or as small as possible). This allows rupture of the membrane at lower threshold pressures, P_{R}, as gas builds up in the cell. Thus for a given cell size, there is a practical lower limit to the burst pressure determined by a maximum radius for the rupturable membrane in the confines of the insulating seal disk 20 and minimum membrane thickness achievable by common molding techniques such as injection molding.

Insulating seal 20 and rupturable membrane 26 may be of polypropylene, talc filled polypropylene, sulfonated ethylene, and nylon, for example, nylon 66 or nylon 612. An anticorrosive coating may optionally be applied to the underside of the insulating sealing disk 20 (including the underside of membrane 26) to enhance the anticorrosive characteristics of insulating seal 20 and prevent surface cracking when the seal is exposed to alkaline electrolyte. Preferred anticorrosive coatings are non reactive with alkaline and nonwetting, for example, Teflon (tetrafluoroethylene) or asphalt or polyamide. The anticorrosive coating material is advantageously applied to the portion of the bottom surface of insulating sealing disk 20 (FIG. 1) immediately underlying rupturable membrane 26, but the entire underside of insulating sealing disk 20 may be coated. Such coating or other sealant material, for example, asphalt or polyamide coating, can also be applied between the peripheral edge 29 of insulating sealing disk 20 and housing 70.

Insulating sealing disk 20 also has a plurality of spaced apart outer integral ribs 19a near the peripheral edge 29 as shown in FIG. 5. There are a plurality of spaced apart inner integral ribs 19b circumventing hub 22. These ribs extend from the top surface of radial arm 21 and are integrally molded into the insulating sealing disk 20. The ribs 19a and 19b serve to provide additional structural support to radial arm 21, that is, making arm 21 resist deflection. A series of radial ribs 13 within hub 22 adds to the compressive strength of the hub 22. There are a plurality of spaced apart legs 23 extending from the underside of peripheral edge 29 of the insulating sealing disk 20 (FIGS. 1A and 6). The legs 23 allow the insulating disk 20 to snap fit around circumferential bead 73 as the insulating disk 20 is inserted into the open end 15 of housing 70.

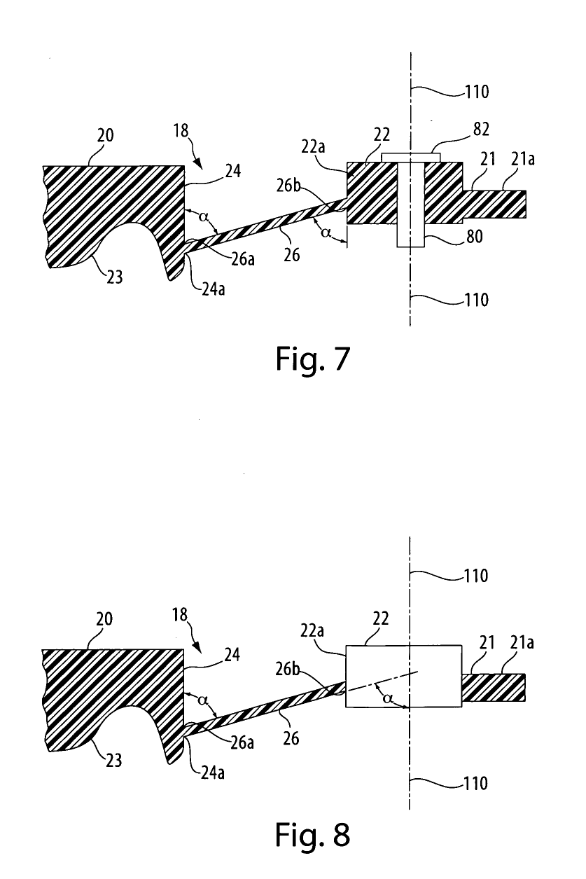

In accordance with the invention the rupturable membrane 26 is sloped so that it has a low point which is closer to the insulating disk peripheral edge 29 and housing interior and a high point which is closer to the sealing disk hub 22 and central longitudinal axis 110, when the cell is viewed in vertical position with the end cap assembly 14 on top (FIG. 1). At least a portion of the rupturable membrane 26 is recessed away from the top surface 21a of radially extending arm 21. The recess is in the direction of the cell interior (FIG. 1). The rupturable membrane 26 is inclined or sloped so that it appears out of the plane of radially extending arm 21. That is, the rupturable membrane appears out of the plane which is perpendicular to the cell's central longitudinal axis 110. The rupturable membrane 26 is oriented at a downward angle, “α”, at the juncture between membrane 26 and vertical hub wall 22a of insulating disk 20 as shown in FIG. 7. The vertical hub wall 22a is parallel to central longitudinal axis 110 (FIG. 1). Thus, the angle “α” can be measured as the angle of intersection of the plane of the rupturable membrane and the cell's central longitudinal axis 110. The plane of the rupturable membrane 26 is inclined so that the high point on the rupturable membrane 26 is closer to the cell's central longitudinal axis 110 than the low point on said rupturable membrane 26, when the cell is viewed in vertical position with the with end cap assembly on top as shown best in FIG. 8. The plane of rupturable membrane 26 is at an incline acute angle “α” of between about 10 and 65 degrees, desirably between about 15 and 40 degrees, preferably at about 32 to 38 degrees with the cell's central longitudinal axis 110 as shown best in FIG. 8. The membrane 26 low point at juncture 26a with the insulating sealing disk peripheral edge inner wall 24 is therefore recessed down from radially extending arm 21 (FIGS. 7 and FIG. 8). This recess of membrane 26 (low point) at juncture 26a from the radially extending arm 21 may be by an amount between about 0.1 and 0.50 mm, typically about 0.38 mm. Such recess results primarily from placement of the plane of membrane 26 at an inclined angle, “α” between about 10 and 55 degrees, desirably at about 24 to 25 degrees with central longitudinal axis 110. The amount of recess can also be deepened somewhat be extending downward the integral connection points for membrane 26, namely, by extending downward the lower portion of the peripheral inner wall 24a and the low point of hub wall 22a (FIG. 7). The recess provides an increased amount of head room 18 (FIGS. 1, 7, and 8) through which membrane 26 can expand until it finally bursts. This produces an advantage over prior art island type rupturable membranes that are not inclined within the insulating sealing disk, that is, are horizontally oriented, namely, perpendicular to central longitudinal axis 110.

The inclined orientation of rupturable membrane 26 in combination with a spaced apart metal support disk 40 positioned over the insulating sealing disk 20 has particular application and advantage when the insulating sealing disk is formed of polypropylene, preferably talc filled polypropylene. The advantage is not intended to be limited to any specific size alkaline cell, but it is greatest in connections with C and D size cells. Insulating sealing disk 20 with the island type rupturable membrane 26 herein described may be made of nylon, e.g. nylon 66 or nylon 612 material, which is alkaline resistant and has a higher softening point than polypropylene. Nylon does not balloon out as much as the same membrane composed of polypropylene or talc filled polypropylene when subjected to the same conditions of cell gas pressure and temperature. However, polypropylene or talc filled polypropylene is more hydrogen permeable than nylon. There is also a major cost savings in employing insulating sealing disk 20 composed of polypropylene or talc filled polypropylene instead of nylon. Particularly, in view of such cost savings it is very desirable to use insulating sealing disk 20 composed of polypropylene, preferably talc filled polypropylene instead of nylon.

The problem encountered with the use of polypropylene or talc filled polypropylene as material for insulating sealing disk 20 and rupturable membrane 26 appears during abuse testing of the cell. When the cell, particularly C and D size cells are subjected to abuse testing conditions, which may involve short circuiting the cell or subjecting the cell to very high external temperatures, e.g. above about 170° F. (77° C.), the polypropylene membrane 26 can soften quickly. As gas pressure in the cell builds under such circumstances, the membrane 26 can balloon into the head space 18 between membrane 26 and metal support disk 40 and impact against the undersurface of metal support disk 40 before it ruptures. When the membrane finally ruptures, clogging of the head space 18 between membrane 26 and metal support disk 40 with anode material from the cell interior can occur. This can retard the rate at which gas pressure from within the cell interior can be reduced. It has been discovered that such clogging is less likely to occur if 1) more head room 18 is provided to assure that membrane 26 will rupture before it balloons into contact with metal support disk 40 and 2) the metal support disk 40 is provided with a plurality of apertures 42 in its surface.

In a first part of the improvement of the present invention, more head room above the rupturable membrane 18 is accomplished by orienting rupturable membrane 26 at a downward incline, that is, downward slope from the hub 22 to the peripheral edge 29 of the insulating disk 20. Thus, it has been determined that by orienting membrane 26 at an inclined angle “α” with hub 22 (FIG. 7) of between about 10 and 55 degrees, preferably about 24 to 25 degrees, enough extra head room can be obtained to greatly reduce the chance that membrane 26 will impact metal support disk 40 before it ruptures. Thus, extra head room 18 is obtained in effect by the recess resulting from orienting the plane of membrane 26 at inclined angle, “α”, with central longitudinal axis 110, as above described, without need to space the bulk of metal support disk 40 at any greater distance from the insulating disk, typically about 3 mm, as is normally employed. (The space between metal support disk 40 and top surface of insulating disk 20 should be a small as possible in order to provide more room in the cell interior for anode and cathode material.) Thus, orienting membrane 26 at an inclined angle, “α” between about 10 and 55 degrees, typically between about 24 to 25 degrees with central axis 110 provides additional head room 18 into which the membrane 26 can expand without the need to increase the spacing between metal support disk 40 and insulating seal 20, per se. The design of the invention employing an inclined island type rupturable membrane avoids the need to use puncture prongs or sharp points emanating from the underside of the metal support disk 40 to puncture membrane 26 prematurely as it expands into headroom space 18. (The use of such puncture prongs have the disadvantage that registration is needed during cell assembly to assure that the prong is aligned over the rupturable membrane.)

In a second part of the improvement of the present invention it has been determined that placement of additional apertures 42 in spaced apart arrangement around the circumference of metal support disk 40 near the peripheral edge thereof, can result in quicker removal of material, e.g. anode material 140 which may be carried into headroom space 18 when membrane 26 ruptures during abuse testing or abusive operation of the cell. (Such abusive testing may involve, for example, subjecting the cell to short circuit or high external temperature). Some venting occurs in the extended openings 42b around central core 42a in metal support disk 40 through which gas may escape. In addition a plurality of openings 42 typically between about 2 and 8, for example, about 4 such openings 42 (FIG. 1A) located near the peripheral edge of metal support disk 40 can be employed effectively to increase the rate of gas and debris removal from the head space 18 when membrane 26 ruptures. Thus, during an abuse testing or abusive cell operation, when membrane 26 ruptures, gas and debris from the cell interior can pass through the ruptured membrane 26, into head space 18, then through such openings 42 in the metal support disk 40. The gas (and debris) can then pass through the space occupied by paper washer 50, namely, between peripheral edge 72 of metal housing 70 and end cap peripheral edge 64 and then out to the external environment. The improved end cap assembly 14 design of the invention with inclined membrane 26 and additional vent holes 42 in metal support disk 40 assures that proper venting of the cell occurs even when subjected to abusive conditions, e.g. short circuit or high external temperatures. This is all achieved while employing preferably a cost effective propylene or talc filled polypropylene insulating sealing disk 20.

In a third part of the improvement of the invention, the inclined orientation of rupturable membrane 26 results in easy capture of the top edge 132 of the separator 130 at juncture 26b between separator edge and vertical hub wall 22a of the insulating disk 20 (FIG. 1). The easy capture of separator 130 is a result of the downward incline of the rupturable membrane 26 from hub wall 22a towards peripheral edge 29 of the insulating sealing disk 20 (FIG. 1). When separator 130 is first inserted into the cell, the sides 133 of the separator abut cathode 120 and the open edge 132 of the separator is vertically aligned. It is desired that the edge 132 become bent inwardly towards hub 22 (FIG. 1) when the end cap assembly 14 is inserted into the open end 15 of housing 70. The inward bending of edge 132 of the separator 130 provides a good seal between anode and cathode, thus assuring that anode material 140 is prevented from mixing with cathode material 120. Since membrane 26 is inclined downward, juncture 26b of the membrane 26 with vertical hub wall 22a is higher than juncture 26a at the opposing end of the membrane as shown in FIGS. 1 and 7. This makes it easy for edge 132 of the separator 130 to slide or be bent inwardly towards hub 22 as shown in FIG. 1 when the end cap assembly 14 is inserted into the cell housing 70. Thus, separator edge 132 slides naturally towards hub vertical wall 22a when the rupturable membrane 26 is inclined as shown in FIG. 1 as compared to a rupturable membrane with no incline, that is, perpendicular to longitudinal axis 110.

The following is a description of representative chemical composition of anode 140, cathode 120 and separator 130 for alkaline cell 10 which may employed irrespective of cell size. The following chemical compositions are representative basic compositions for use in cells having the end cap assembly 14 of the present invention, and as such are not intended to be limiting.

In the above described embodiments the cathode 120 can comprise manganese dioxide, graphite and aqueous alkaline electrolyte; the anode 140 can comprise zinc and aqueous alkaline electrolyte. The aqueous electrolyte comprises a conventional mixture of KOH, zinc oxide, and gelling agent. The anode material 140 can be in the form of a gelled mixture containing mercury free (zero-added mercury) zinc alloy powder. That is, the cell can have a total mercury content less than about 50 parts per million parts of total cell weight, preferably less than 20 parts per million parts of total cell weight. The cell also preferably does not contain any added amounts of lead and thus is essentially lead-free, that is, the total lead content is less than 30 ppm, desirably less than 15 ppm of the total metal content of the anode. Such mixtures can typically contain aqueous KOH electrolyte solution, a gelling agent (e.g., an acrylic acid copolymer available under the tradename CARBOPOL C940 from B.F. Goodrich), and surfactants (e.g., organic phosphate ester-based surfactants available under the tradename GAFAC RA600 from Rhône Poulenc). Such a mixture is given only as an illustrative example and is not intended to restrict the present invention. Other representative gelling agents for zinc anodes are disclosed in U.S. Pat. No. 4,563,404.

The cathode 120 can desirably have the following composition: 87-93 wt % of electrolytic manganese dioxide (e.g., Trona D from Kerr-McGee), 2-6 wt % (total) of graphite, 5-7 wt % of a 7 to 9 Normal aqueous KOH solution having a KOH concentration of about 30-40 wt %; and 0.1 to 0.5 wt % of an optional polyethylene binder. The electrolytic manganese dioxide typically has an average particle size between about 1 and 100 micron, desirably between about 20 and 60 micron. The graphite is typically in the form of natural, or expanded graphite or mixtures thereof. The graphite can also comprise graphitic carbon nanofibers alone or in admixture with natural or expanded graphite. Such cathode mixtures are intended to be illustrative and are not intended to restrict this invention.

The anode material 140 comprises: Zinc alloy powder 62 to 69 wt % (99.9 wt % zinc containing 200 to 500 ppm indium as alloy and plated material), an aqueous KOH solution comprising 38 wt % KOH and about 2 wt % ZnO; a cross-linked acrylic acid polymer gelling agent available commercially under the tradename “CARBOPOL C940” from B.F. Goodrich (e.g., 0.5 to 2 wt %) and a hydrolyzed polyacrylonitrile grafted onto a starch backbone commercially available commercially under the tradename “Waterlock A-221” from Grain Processing Co. (between 0.01 and 0.5 wt. %); dionyl phenol phosphate ester surfactant available commercially under the tradename “RM-510” from Rhone-Poulenc (50 ppm). The zinc alloy average particle size is desirably between about 30 and 350 micron. The percent by volume of the aqueous electrolyte solution in the anode is preferably between about 69.2 and 75.5 percent by volume of the anode. The cell can be balanced in the conventional manner so that the mAmp-hr capacity of MnO₂ (based on 308 mAmp-hr per gram MnO₂) divided by the mAmp-hr capacity of zinc alloy (based on 820 mAmp-hr per gram zinc alloy) is about 1.

A heat shrinkable label 35, typically of polyvinylchloride or polypropylene may be applied around the side wall 74 of housing 70. Label 35 has a top edge 36 which is heat shrinkable over peripheral edge 64 of end cap 60 and a bottom edge 37 which is heat shrinkable over a portion of housing closed end 17.

The end cap assembly 14 of the invention can be applied to closing and sealing alkaline cells having other anode and cathode chemistries besides the zinc/MnO₂ cell described herein. For example, the improved end cap assembly 14 and improved sealing disk 20 of the invention described herein may be used advantageously in alkaline cells having anodes comprising zinc and cathode comprising nickel oxyhydroxide. An example of such alkaline cell is described in commonly assigned U.S. Pat. No. 6,991,875 B2. The invention can also be applied generally to electrochemical cells having a tendency to produce gases in the cell interior, particularly under abusive conditions such as short circuit testing or exposure to very high external temperatures.

Although the present invention has been described with respect to specific embodiments, it should be appreciated that variations are possible within the concept of the invention. Accordingly, the invention is not intended to be limited to the specific embodiments described herein but will be defined by the claims and equivalents thereof.

What is claimed is:

1. An alkaline electrochemical cell comprising a housing having an open end an opposing closed end and cylindrical side wall therebetween and an end cap assembly inserted into said open end closing said housing; said end cap assembly comprising a support disk comprising metal and an underlying electrically insulating sealing disk when the cell is viewed in vertical position with the end cap assembly on top; wherein at least a substantial portion of said metal support disk is in juxtaposed spaced apart relationship with said insulating sealing disk; wherein said insulating sealing disk has a central hub and a radial arm extending radially from said hub; and wherein said insulating sealing disk has a thinned portion forming a rupturable membrane in said radial arm, said rupturable membrane having a downwardly extended surface extending downwardly from a high point on said surface to low point thereon, said downwardly extended surface being inclined so that said high point is closer to the cell's central longitudinal axis than said low point when the cell is viewed in vertical position with the end cap assembly on top; wherein said rupturable membrane is in spaced apart relationship with said metal support disk and does not contact said support disk; whereby when gas pressure within the cell rises, said rupturable membrane ruptures thereby releasing gas into the space between said insulating sealing disk and said metal support disk.

2. The cell of claim 1 wherein said rupturable membrane has a surface in a plane which intersects the cell's central longitudinal axis at an acute angle between about 10 and 65 degrees.

3. The cell of claim 1 wherein said rupturable membrane has a surface in a plane which intersects the cell's central longitudinal axis at an acute angle between about 20 and 40 degrees.

4. The cell of claim 1 wherein said radially extending arm has a top surface facing the open end of said housing and at least a portion of said rupturable membrane is recessed away from said top surface of said radially extending arm within said insulating sealing disk, said recess being in a direction towards said cell interior, thereby increasing the head space between said rupturable membrane and said metal support disk.

5. The cell of claim 1 wherein said radially extending arm in said insulating sealing disk is perpendicular to the cell's central longitudinal axis.

6. The cell of claim 1 wherein the rupturable membrane has opposing major surfaces which are flat.

7. The cell of claim 1 wherein said rupturable membrane has a thickness between about 0.06 and 0.50 mm.

8. The cell of claim 1 wherein said rupturable membrane has a top surface area of between about 10 and 40 mm², when the cell is viewed with the end cap assembly on top.

9. The cell of claim 1 wherein at least the region between the peripheral edge and central core of said metal support disk is spaced apart from said insulating sealing disk and does not contact said insulating sealing disk.

10. The cell of claim 1 wherein said metal support disk has at least one vent aperture therethrough.

11. The cell of claim 1 wherein said metal support disk has a plurality of vent apertures therethrough located adjacent the peripheral edge of said support disk.

12. The cell of claim 1 wherein said insulating sealing disk comprises polypropylene or talc filled polypropylene.

13. The cell of claim 1 wherein said end cap assembly further comprises an insulating washer and an end cap comprising metal, wherein said insulating washer is located over said metal support disk and said end cap is located over said insulating washer, when the cell is viewed in vertical position with the end cap assembly on top.

14. The cell of claim 13 wherein said insulating washer comprises paper.

15. The cell of claim 13 wherein said end cap assembly further comprises an elongated current collector in electrical contact with said end cap and extending into the cell interior.

16. In an alkaline electrochemical cell having a housing comprising an open end an opposing closed end and cylindrical side wall therebetween and an end cap assembly inserted into said open end closing said housing; said end cap assembly comprising a support disk comprising metal and an underlying electrically insulating sealing disk when the cell is viewed in vertical position with the end cap assembly on top; wherein at least a substantial portion of said metal support disk is in juxtaposed spaced apart relationship with said insulating sealing disk; wherein said insulating sealing disk has a central hub and a radial arm extending radially from said hub, the improvement comprising:
said insulating sealing disk having a thinned portion forming a rupturable membrane in said radial arm, said rupturable membrane having a downwardly extended surface extending downwardly from a high point on said surface to low point thereon, said downwardly extended surface being inclined so that said high point is closer to the cell's central longitudinal axis than said low point when the cell is viewed in vertical position with the end cap assembly on top; wherein said rupturable membrane is in spaced apart relationship with said metal support disk and does not contact said support disk; whereby when gas pressure within the cell rises, said rupturable membrane ruptures thereby releasing gas into the space between said insulating sealing disk and said metal support disk.

17. The cell of claim 16 wherein said rupturable membrane has a surface in a plane which intersects the cell's central longitudinal axis at an acute angle between about 10 and 65 degrees.

18. The cell of claim 16 wherein said rupturable membrane has a surface in a plane which intersects the cell's central longitudinal axis at an acute angle between about 20 and 40 degrees.

19. The cell of claim 16 wherein said radially extending arm has a top surface facing the open end of said housing and at least a portion of said rupturable membrane is recessed away from said top surface of said radially extending arm within said insulating sealing disk, said recess being in a direction towards said cell interior, thereby increasing the head space between said rupturable membrane and said metal support disk.

20. The cell of claim 16 wherein said radially extending arm in said insulating sealing disk is perpendicular to the cell's central longitudinal axis.

21. The cell of claim 16 wherein the said rupturable membrane has opposing major surfaces which are flat.

22. The cell of claim 16 wherein said rupturable membrane has a thickness between about 0.06 and 0.50 mm.

23. The cell of claim 16 wherein said membrane has a top surface area of between about 10 and 40 mm², when the cell is viewed with the end cap assembly on top.

24. The cell of claim 16 wherein at least the region between the peripheral edge and central core of said metal support disk is spaced apart from said insulating sealing disk and does not contact said insulating sealing disk.

25. The cell of claim 16 wherein said metal support disk has at least one vent aperture therethrough.

26. The cell of claim 16 wherein said metal support disk has a plurality of vent apertures located adjacent the peripheral edge of said support disk.

27. The cell of claim 16 wherein said insulating sealing disk comprises polypropylene or talc filled polypropylene.

28. The cell of claim 16 wherein said end cap assembly further comprises an insulating washer and an end cap comprising metal, wherein said insulating washer is located over said metal support disk and said end cap is located over said insulating washer, when the cell is viewed in vertical position with the end cap assembly on top.

29. The cell of claim 28 wherein said insulating washer comprises paper.

30. The cell of claim 28 wherein said end cap assembly further comprises an elongated current collector in electrical contact with said end cap and extending into the cell interior.
